(19) United States
(12) Patent Application Publication
(10) Pub. No.: US 2023/0339676 A1
(43) Pub. Date: Oct. 26, 2023

(54) WASTE STORAGE FILM REFILL

(71) Applicant: Sangenic International Limited, Newcastle upon Tyne (GB)

(72) Inventor: Scott Rontree, Newcastle upon Tyne (GB)

(21) Appl. No.: 18/028,898

(22) PCT Filed: Sep. 16, 2021
(86) PCT No.: PCT/GB2021/052408

§ 371 Date: Mar. 28, 2023

(30) Foreign Application Priority Data
Sep. 28, 2020 (GB) 2015338.3

(51) Int. Cl. B65F 1/06; B65F 1/14; B65F 1/16

(52) U.S. Cl. CPC B65F 1/062; B65F 1/1426; B65F 1/1607; B65F 2210/1675; B65F 2240/132

(57) ABSTRACT

A waste storage refill (210) for a waste storage cassette (172) to be mounted in a waste storage device (100). The waste storage refill comprises a tubular film (206) folded over in alternate directions to form concentric pleats such that pulling an end of the tubular film axially expands the pleats. A waste storage cassette to receive the waste storage refill and a waste storage device to mount the waste storage cassette are also disclosed.

### TECHNICAL FIELD

The invention relates to a waste storage refill. In particular, the present invention relates to a waste storage refill for a waste storage cassette to be mounted in a waste storage device, for storing waste products such as nappies. Certain examples relate to a waste storage cassette filled with such a waste storage refill and a waste storage device including such a waste storage cassette.

### BACKGROUND

The problem of how to effectively seal and store nappy waste is well recognised. It is possible to store nappy waste in ordinary household bins; however these are not sufficiently smell proof to enable nappy waste to be hygienically stored except on a very temporary basis. Plastic bags may be used to wrap soiled nappies and other waste in an attempt to block smell leakage, however these bags have limited effect and often comprise more plastic than is needed to wrap a single nappy, therefore creating unnecessary waste.

Several known devices exist which provide means for sealing and storing nappy waste. One known device which is designed for the storage of nappy waste is a waste storage device for housing a waste storage cassette. The waste storage cassette dispenses a tubular film from a storage section, through a tubular core. A waste item is inserted through the tubular core such that it is enveloped by the tubular film to form a waste package. The waste storage device includes a rotator which is configured to rotate the cassette relative to the waste package thereby twisting the tubular film to form a twisted seal above the waste package. The twisted seal also acts as the base of a length of tubular film for packaging the next waste item to be disposed of.

In an alternative waste storage device, the waste storage cassette may not rotate such that the tubular film is filled without twisting as waste items are inserted through the tubular core.

The waste storage devices noted above provide a hygienic solution to disposing of waste items such as nappy waste. The waste storage cassette is a replaceable part, comprising a plastic housing having an inner wall (defining a substantially tubular core) and an outer wall defining the storage section therebetween which is filled with tubular film. An end of the tubular film may be drawn from the storage section, passed through the tubular core and knotted off ready to receive the first waste item. Once the tubular film is exhausted, the waste storage cassette may be replaced.

However, it will be appreciated that replacing the waste storage cassette involves not just the replacement of the tubular film, which is inevitably consumed through use of the waste storage device, but also the plastic housing itself. The plastic housing may be recycled or sent to landfill.

It is an aim of certain embodiments of the invention to solve, mitigate or obviate, at least partly, at least one of the problems and/or disadvantages associated with the prior art. Particularly, it is an aim of certain embodiments of the present invention to minimise the materials consumed when using a waste storage device. Reduced material consumption offers environmental benefits and may also offer cost savings to the consumer.

### SUMMARY OF THE INVENTION

According to a first aspect of the present invention there is provided a waste storage refill for a waste storage cassette to be mounted in a waste storage device, the waste storage refill comprising: a tubular film folded over in alternate directions to form concentric pleats such that pulling an end of the tubular film axially expands the pleats.

The pleats may be disposed circumferentially such that each pleat is parallel to the axis of the tubular film. Each pleat may comprise an approximately equal length of the tubular film.

One end of the tubular film may protrude from the concentric pleats such that it may be pulled to axially expand the pleats.

The concentric pleats may be squashed together across the dimeter of the tubular film to form a flattened package that is openable such that the concentric pleats form a ring. The depth of the stacked concentric pleats in the flattened package may be between 45 mm and 55 mm thick. Each pleat may be between 70 mm and 80 mm in the axial direction of the tubular film. The length of the flattened package may be between 261 mm and 267 mm.

The tubular film may be formed from a plastic or bioplastic.

The tubular film may be between 0.005 mm and 0.02 mm thick. It may be 0.012 mm thick, ±10%.

According to a second aspect of the present invention there is provided a waste storage cassette for mounting in a chamber provided in a waste storage device, the waste storage cassette comprising: an inner wall defining a substantially tubular core; an outer wall; a storage section provided between the inner wall and the outer wall; and a waste storage refill as described above; wherein the waste storage refill is located within the storage section surrounding the tubular core.

The outer wall may include at least one engagement feature configured to locate and engage with a corresponding engagement feature within the waste storage device.

The waste storage cassette may further comprise a flange detachably coupled to an upper edge of the outer wall and extending radially inward to at least partly cover the storage section.

According to a third aspect of the present invention there is provided a waste storage device comprising: a receiving chamber provided in an upper part of the device; and a waste storage cassette as described above; wherein the receiving chamber is configured to receive the waste storage cassette; and wherein waste inserted into the waste storage device passes through the tubular core of the waste storage cassette and is enveloped in the tubular film drawn from the storage section.

The receiving chamber may be configured such that the waste storage cassette can rotate relative to the receiving chamber, the waste storage device further comprising a rotator rotatably mounted in the receiving chamber and configured to engage the waste storage cassette to ensure rotational engagement between the rotator and the cassette.

The waste storage cassette may be separable from the waste storage device.

According to a fourth aspect of the present invention there is provided a method of refilling a waste storage cassette, the waste storage cassette comprising an inner wall defining a substantially tubular core, an outer wall and a storage section provided between the inner wall and the outer wall, the method comprising: inserting a waste storage refill as described above into the storage section such that the concentric pleats of the tubular film surround the tubular core.

The waste storage cassette may further comprise a flange detachably coupled to an upper edge of the outer wall and extending radially inward to at least partly cover the storage section, and the method may further comprise detaching the flange from the outer wall prior to inserting the waste storage refill into the storage section, and replacing the flange afterwards.

The method may further comprise pulling an end of the tubular film from the storage section, passing the end of the tubular film through the tubular core and knotting the end of the tubular film.

Advantageously, the waste storage refill may be used to refill an existing waste storage cassette with film, without requiring the replacement of a plastic housing part of the cassette.

### FIGURES

Embodiments of the invention are further described hereinafter with reference to the accompanying drawings, in which:

FIG. 1 is a perspective view of a waste storage device;

FIG. 2 is a perspective view of the waste storage device of FIG. 1, including a waste storage cassette;

FIG. 3 is a side view of a lid of a waste storage device, including a plunger;

FIG. 4 is a bottom perspective view of a waste storage device cover;

FIGS. 5a and 5b are alternative perspective views of a rotator;

FIGS. 6a to 6c are alternative perspective views of a waste storage cassette;

FIG. 7 is a perspective view of the cassette of FIGS. 6a to 6c suspended from the rotator of FIGS. 5a and 5b;

FIG. 8 is a cross section view of a waste storage cassette loosely filled with tubular film;

FIG. 9 is a cross section view of a waste storage cassette into which there is inserted a waste storage refill comprising a concentrically pleated tubular film according to an embodiment of the present invention;

FIG. 10 illustrates a waste storage refill according to an embodiment of the present invention; and

FIGS. 11a to 11f illustrate the process of refilling an empty waste storage cassette with a waste storage refill according to an embodiment of the present invention.

### DETAILED DESCRIPTION

Before describing a waste storage refill according to an embodiment of the present invention, there will now be provided an overview of a waste storage device and a waste storage cassette suitable for use with the waste storage refill.

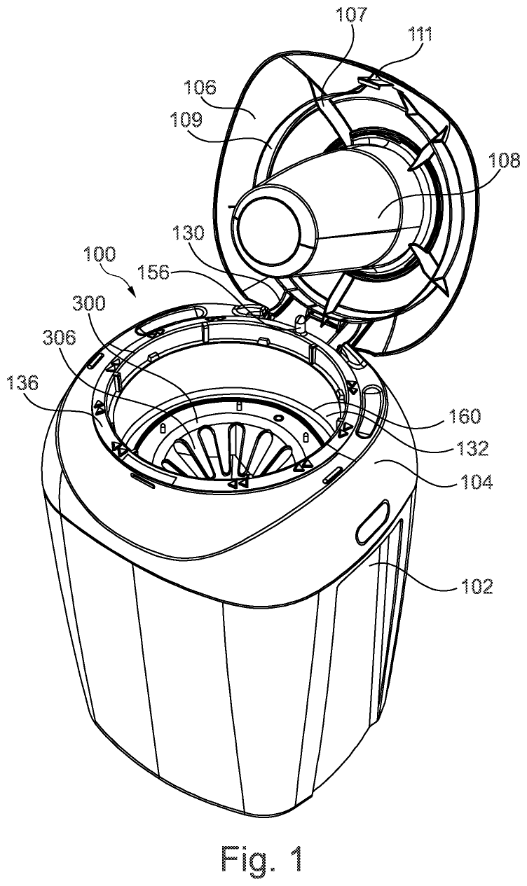

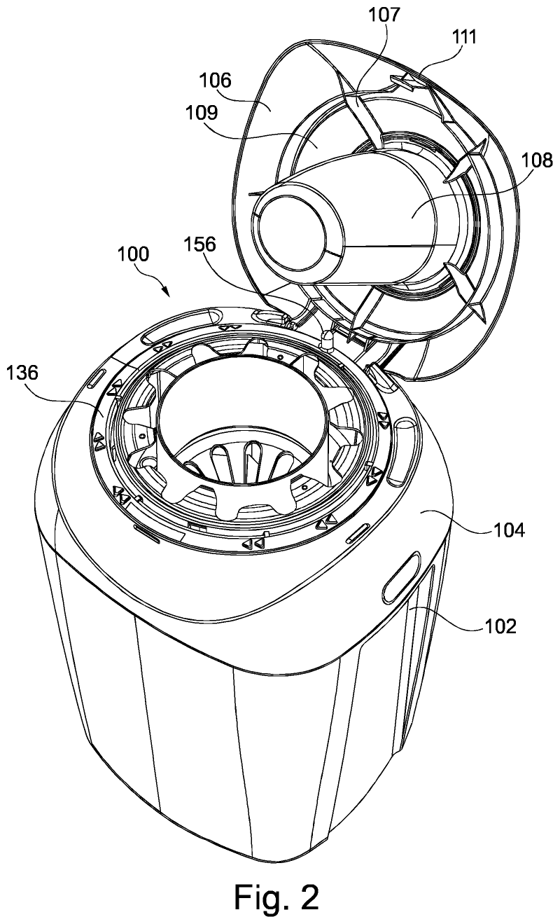

Referring to FIGS. 1 and 2, a waste storage device can be seen. The waste storage device 100 includes a waste storage chamber 102 having a removable cover 104. As described in more detail below, the removable cover 104 includes a waste cassette receiving chamber 132 for receiving a waste storage cassette having flexible tubing for enveloping waste items and further includes a waste storage cassette rotator 136. The rotator provides means for rotating a waste storage cassette with respect to the waste cassette receiving chamber in order to create sealed waste packages in the flexible tubing.

The waste cassette rotator 136 further includes a handle 156 which can be actuated by a user in order to rotate the waste cassette rotator 136 about its central axis in the waste cassette receiving chamber 132. The waste storage chamber 102 and removable cover 104 may fit together by any suitable means such as a tab and cooperating recess.

The removable cover 104 includes a lid 106. The lid 106 is preferably attached to the cover 104 through a hinge such that it can be actuated in order to provide user access to the inside of the cover 104.

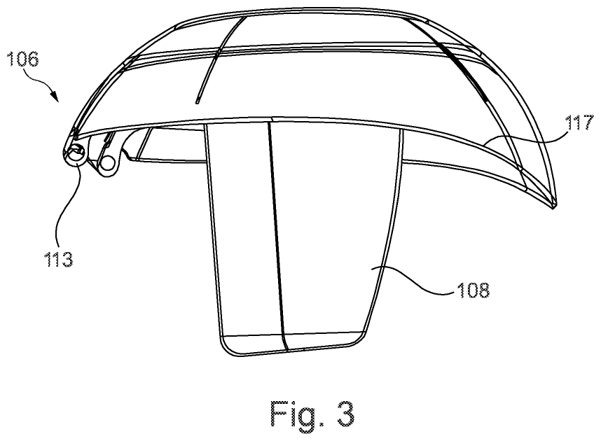

FIG. 1 shows an embodiment of the waste storage device 100 with the lid 106 in an open position. FIG. 2 shows an embodiment of the waste storage device 100 with the lid 106 in an open position, and with a waste storage cassette inserted into the waste storage cassette receiving chamber 132. FIG. 3 shows a side view of the lid removed from the waste storage device.

The cover 104 of the waste storage container comprises a waste cassette receiving chamber 132 configured to receive a waste storage cassette. A plunger 108 extends downwardly from an under surface of the lid 106. The plunger is fixed relative to the lid so that movement of the lid provides movement of the plunger. Preferably the plunger 108 and lid 106 share a common central axis along the extension direction of the plunger 108. The plunger 108 may be hollow, with an open upper end covered by the lid 106 and a closed lower end. According to an embodiment of the invention, the plunger 108 is substantially circular in cross section and tapers radially inwards towards its lower end. This tapering provides clearance for insertion of the plunger 108 into a throat or other waste aperture defined within the removable cover 104 when the lid 106 is closed, as described in more detail below. The plunger 108 may be formed integral to the lid 106 or may attach to the lid 106 by any appropriate inter—engagement means such as a screw fit or snap fit. Optionally, the portion of the lid 106 which covers the upper end of the plunger 108 may be removable.

In order to support the plunger 108 and prevent the lid 106 from deforming under its weight, a plurality of support ribs 107 are provided on the under surface of the lid 106. Preferably the support ribs 107 are spaced apart from one another around the circumference of the upper end of the plunger 108 and each rib 107 extends radially outwards therefrom. Optionally, the lid 106 may include an annular flange 109 extending downwardly from the under surface of the lid 106, wherein the annular flange 109 intersects the support ribs 107 towards their distal ends in order to provide additional support.

A clip 111 is provided at the front of the lid 106, extending from its under surface. The clip 111 inter-engages with a cooperating slot or recess on an outer surface of the removable cover 104, in order to secure the lid 106 in a closed configuration to the cover 104. In an alternative embodiment the lid 106 can lock to the main body of the cover 104 via any appropriate means.

At its back end the lid 106 has a further plurality of ribs on its under surface, preferably extending parallel to one another and outwardly from an outer surface of the annular flange 109. According to an embodiment, the further plurality of ribs includes two hinge ribs 113 which flank two engagement ribs 130. The hinge ribs 113 each include a hole, recess or protrusion towards its distal end, close to the outer edge 117 of the lid 106, for cooperation with a corresponding protrusion, hole or recess on the cover 104, to form a hinged attachment between the lid 106 and cover 104.

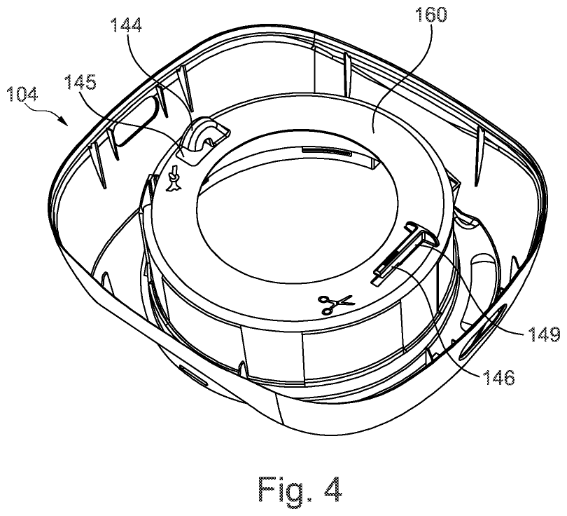

As shown in FIG. 4, the underside of the removable cover 104 includes a hook 144 and cutter 146. The removable cover 104 comprises an annular flange 160. The hook 144 is preferably substantially C-shaped, extending downwardly from an underside of the annular flange 160 and curving upwardly back towards the flange 160, with a small gap 145 defined between the flange 160 and the distal end of the hook 144. When a waste cassette is placed in the waste cassette receiving chamber 132 the user pulls a substantially cylindrical length of tubing from the top of the cassette and ties the tubing into a knot near its upper edge. This knotted tubing forms the base of a waste package into which a nappy or other waste item(s) can be placed. After a waste item has been placed in the tubing, the top of the waste package will be formed by making a twist in the tubing as described below. This twist will then form the base of a subsequent waste package.

Optionally, before a waste item is placed in the waste package the user pushes the knotted base downwards, through an open gripping assembly, and at least partially into the waste passage below. This ensures that sufficient tubing will be available to cover the waste item and to enable the tubing above the waste item to be effectively sealed.

In order to hold a length of tubing containing one or more individually wrapped waste packages in place, and to prevent unravelling of the twist formed above any individual waste package, particularly the first waste package formed within a length of tubing, the knot in the upper edge of the length of tubing is inserted into the hook 144 on the underside of the waste cassette receiving chamber 132. The hook 144 holds the knot in place so that after several uses of a waste storage cassette in the waste storage device 100 a chain of individually wrapped waste packages will extend from the hook 144, down into the waste storage chamber 102 and back up towards the waste storage cassette from which the tubing extends.

As described below, the cutter 146 can be used to cut flexible tubing from a waste storage cassette. The cutter preferably includes a tapered ramp 149 extending from the underside of the flange 160 and a blade or other cutting means provided substantially coplanar with the flange 160 and protected from below by the ramp 149. The tapered portion of the ramp 149 acts as a guide to direct flexible tubing or other material towards the protected cutting means for severance of the material.

In use, when a user wishes to remove the stored waste packages from the waste storage chamber 102 of a waste storage device 100, the tubing which envelops the waste packages must be severed from the unused tubing extending from the cassette. In order to do this, the cover 104 is removed from the waste storage chamber 102. According to a preferred embodiment, the cover 104 can be turned on its side and can rest in a stable position in the mouth of the waste storage chamber 102, to enable the user to more easily cut the flexible tubing without having to hold the cover 104 at the time. The tubing between the top of the cassette and the tubing enveloping the most recently formed waste package is then sliced or otherwise severed using the cutter 146. The user can then unhook the knotted end of the chain of waste packages from the hook 144 and dispose of the waste packages thereafter.

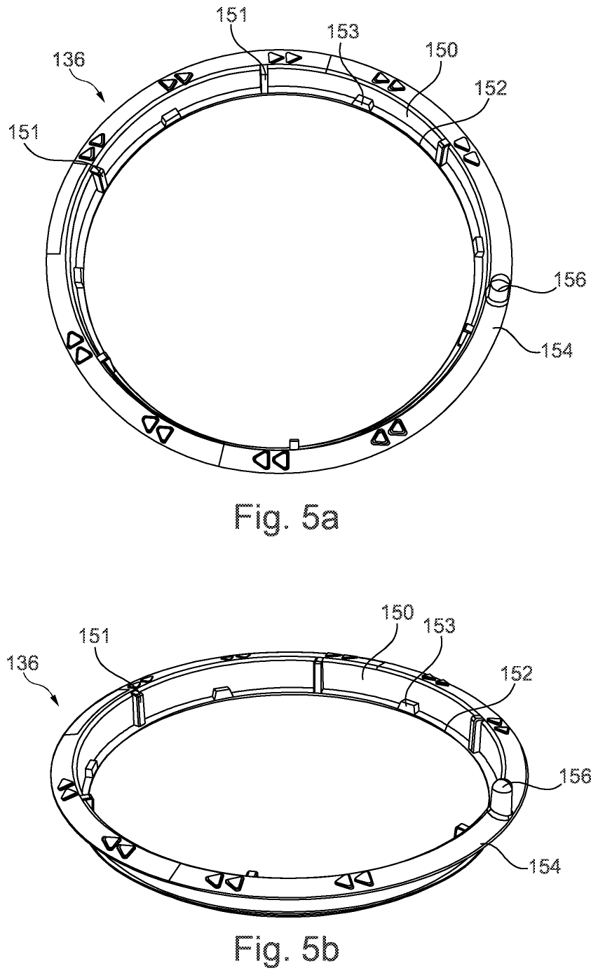

Referring to FIGS. 5a and 5b, a waste cassette rotator 136 can be seen. The waste cassette rotator 136 comprises a cylindrical wall 150 extending substantially concentric with the walls of the cassette receiving chamber, a flange or annular base 152 extending radially inward and substantially perpendicular to the wall 150, and an upper annulus 154 which extends radially outwards from the top of the wall 150 so that it can rest on an upper surface of the cover 104.

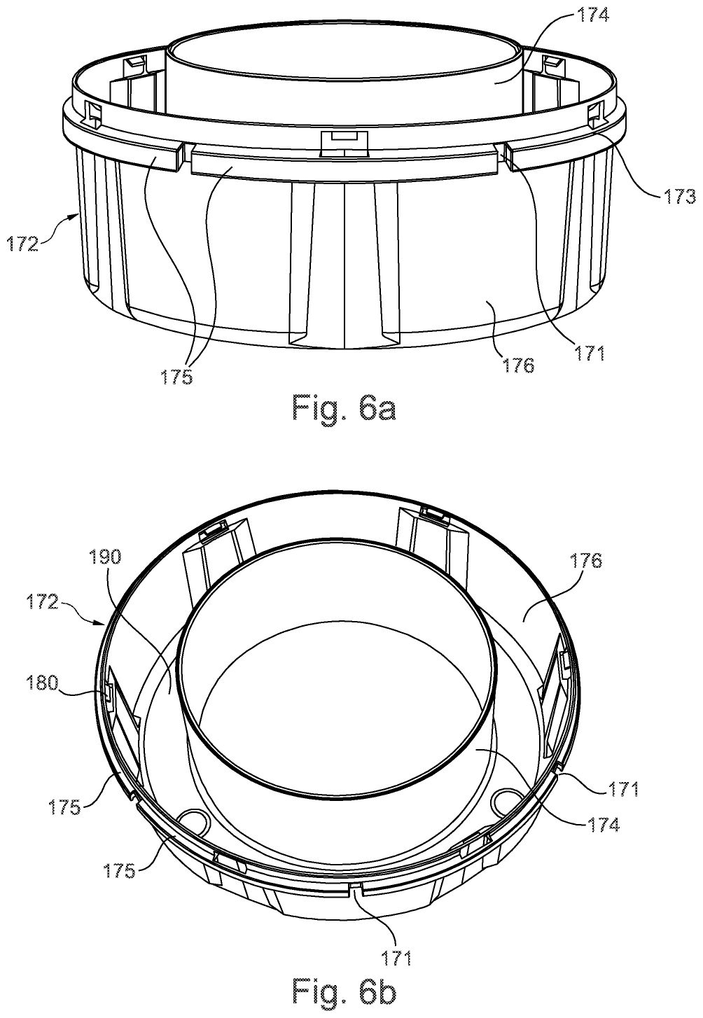

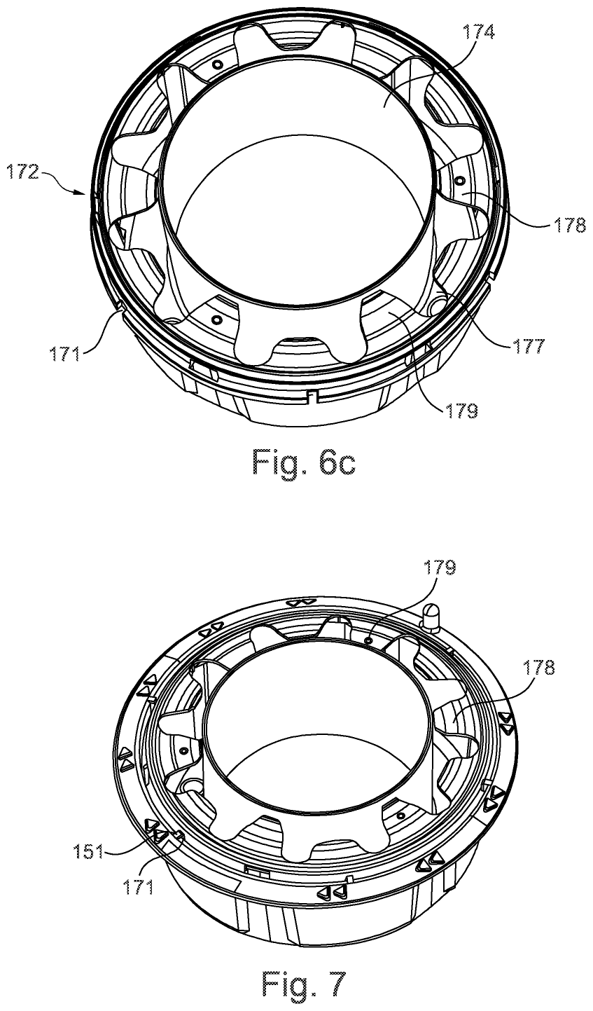

According to a preferred embodiment the waste cassette rotator 136 further includes a handle 156 on its upper annulus 154 which can be actuated by a user in order to rotate the waste cassette rotator 136 about its central axis in the waste cassette receiving chamber 132. The waste cassette rotator 136 is arranged for supporting and housing a waste storage cassette 172 as shown in FIGS. 6a and 6b and for rotating said cassette 172 with respect to the waste cassette receiving chamber 132 as described in more detail below.

The waste cassette rotator 136 further includes a plurality of generally vertically extending ribs 151 which project in a radially inward direction from the inner wall. The ribs 151 project inwardly flush with the flange 152 and in contact with the flange 152, and are thus supported across their base by the flange 152. The ribs 151 may be spaced substantially equidistantly around the inner circumference of the cylindrical wall 150, or may be at varying coplanar separations, or equally angularly spaced but omitting one or more ribs. The ribs 151 extend, in a direction substantially parallel to the central axis of the rotator, between the upper annulus 154 and the flange 152. The ribs are sized, positioned and shaped in an appropriate manner to engage with corresponding slots 171 on a waste storage cassette, as will be described below.

In an alternative embodiment, and with reference to FIGS. 5a to 6c, the rotator also includes a plurality of raised projections 153 interspaced between the ribs 151. The raised projections 153 may be equally interspaced around the circumference of the cylindrical wall 150, or may be positioned in any suitable arrangement around the annular flange 152 of the rotator. The raised projections 153 extend in an upward direction from the flange 152 and in contact with the cylindrical wall 150, and extend at least part of the distance between the flange 152 and the upper annulus 154. The raised projections have a radial dimension substantially equal to that of the flange 152, and extend in a tangential direction around the flange 152.

The raised projections 153 enable the rotate ring 136 to receive different sized cassettes. For example, the radially extending protrusions 175 which comprise the annular formation 173 of the cassette, as will be described in greater detail later, can be arranged to rest on either the raised projections 153 or the annular base 152 of the rotate ring. For a shallower cassette, i.e. a cassette having a smaller cylindrical height, the cassette formation 173 can be designed to rest on the raised projections 153. For a deeper cassette, i.e. a cassette having a larger cylindrical height, the cassette formation 173 can be designed to rest directly on the flange 152. In a cassette according to this embodiment, gaps (not shown) in the formation 173 are provided. These gaps are positioned, sized and shaped appropriately in order to allow the raised projections 153 to pass through the gaps, thereby allowing a bottom surface of the formation 173 to rest directly on the annular flange of the rotate ring. The raised projections thereby allow cassettes of different sizes to fit in the waste storage chamber of the waste storage device, and allow cassettes of different sizes, and/or with differing amounts of film storage space, to be compatible with the same rotate ring.

FIGS. 6a to 6c show a waste storage cassette 172 for use within the waste storage device. The waste storage cassette 172 has a housing which comprises cylindrical inner 174 and outer 176 walls, connected at their lower end by a base 190 to form a substantially U shaped cross section throughout. A storage section is defined between the inner 174 and outer 176 walls of the cassette 172 to store flexible tubing. The flexible tubing may be randomly stuffed or filled into the storage section by machine during the manufacturing process for the waste storage cassette. As can be seen in FIG. 6c, extending radially inward from the upper edge of the outer wall 176 is a flange 178. The flange 178 provides at least a partial cover for the cassette housing, preferably exerting downward pressure on the flexible tubing and keeping it as tightly packed in the housing as possible. There is at least one peripheral gap 177 formed between an outer rim of the flange 178 and the inner wall 174, through which a user can access the flexible tubing in order to pull it over the inner wall 174.

Preferably, the inner wall 174 has a rounded profile at its upper edges in order to provide minimal friction, hence enabling smooth flow of flexible tubing thereover.

As is best seen from FIGS. 6c and 7, according to a preferred embodiment the flange 178 comprises a plurality of inward projections or petals 179 extending from the outer wall 176 towards the inner wall 174 of the cassette 172, with a plurality of gaps 177 therebetween which allow flexible tubing to be dispensed from the cassette housing below. The flange 178 can be clipped, snap-fitted or engaged to the outer wall 176 using any suitable means. Preferably the outer edge of the flange 178 is rounded so as to prevent snagging of the tubing when it passes there over.

Preferably, the flange 178 clips or snap fits into the outer wall 176 of the waste storage cassette 172. According to a preferred embodiment, the outer wall 176 includes one or more inwardly extending protrusions 180 on its inner surface with which the flange 178 engages. Further preferably, the tips of the petals 179, and hence the inner edge of the flange 178, are raised with respect to the outer circumference of the flange.

It will be appreciated from the description below that during use of a waste storage cassette 172 in a waste storage device 100 the petals 179 of the flange 178 improve dosage of the flexible tubing from the cassette housing. In particular, they apply tension to the flexible tubing as it is drawn from the storage section and provide support so that when a relatively heavy waste item is placed in a hollow formed from flexible tubing already dispensed from the cassette 172, the waste item is held in place and its weight does not cause additional tubing to be dispensed from the cassette housing unnecessarily. This is particularly important when there is only a small amount of flexible tubing remaining in the cassette housing, at which time the tubing will not be tightly packed enough to remain trapped in the housing merely due to the covering and downward pressure which the presence of the flange 178 provides.

The petals 179 may each extend to reach the inner wall 174. By extending the petals 179 to reach the inner wall 174 the drag which the flange 178 exerts on the flexible tubing as it is dispensed from the cassette housing is increased. Furthermore, longer petals 179 serve to cover the majority of the flexible tubing in the cassette 172 and prevent it from spilling out before dispensing is required.

According to an alternative embodiment not all of the petals 179 reach the inner wall 174. For example in a cassette 172 having a total of six petals 179 as few as three petals 179, each of a short arc length, should be sufficient to enable adequate user access to the tubing housed therein.

The waste storage cassette 172 further includes a formation 173. The formation takes the form of an annular ledge or flange, which projects radially outwards from an outer surface of the cassette outer wall 176. The formation/ledge 173 is preferably located towards the upper edge of the outer wall 176, but below the flange 178 which extends radially inwards from an inner surface of the outer wall 176.

The formation 173 comprises a number of protrusions 175. The protrusions 175 extend radially outward from an outer surface of the cassette outer wall 176, and are separated by a corresponding number of gaps or slots 171. The slots 171 may be spaced substantially equidistantly around the inner circumference of the cylindrical wall 150, or may be at varying coplanar separations, or equally angularly spaced but omitting one or more slots around the outer circumference of the formation 173, and are positioned, sized and shaped appropriately in order to engage with the ribs 151 of the rotator 136. The protrusions 175 and slots 171 thus comprise one or more engagement feature for engaging the rotator 136 such that rotation of the rotator 136 drives rotation of the waste storage cassette 172.

FIG. 7 shows a cassette 172 coupled with a rotator 136. In coupling the cassette 172 with the rotator 136, the slots 171 have accepted the ribs 151, and the rotator and cassette are ready for synchronous rotation.

Also provided in the waste storage device shown FIGS. 1 and 2 is a gripping assembly or gripper 300. The gripping assembly comprises a gripping diaphragm. The gripping diaphragm comprises a main body having a central aperture. The central aperture can be circular or of any other appropriate profile. The gripper has a plurality of projecting fingers 306 projecting into the aperture, effectively forming a continuous engagement face but providing additional flexibility. The projecting fingers are arranged to contact an enveloped waste package when the waste storage device 100 is in use. As a result the gripper provides a clear engagement feel when a package is inserted and held in place so that the user can detect by tactile feedback that the arrangement is ready to twist the tubing above the gripped package. Yet further the effectively continuous engagement face provided by the aperture periphery such as the fingers 306 ensures that the tubing is gripped consistently around its circumference.

The gripping assembly connects to the flange 160 of the removable cover 104, thus forming the base of the waste cassette receiving chamber 132. The gripper 300 is preferably removably secured by inter-engagement means to an upper face of the flange 160. The plurality of projecting fingers extend downwardly and inwardly into the ‘throat’ of the waste storage chamber 102.

Referring to FIG. 2, a waste storage cassette 172 is seen in situ in the waste cassette receiving chamber 132 of a waste storage device 100. The cassette 172 is placed in the waste cassette receiving chamber 132, preferably wherein the cassette 172 hangs via the ledge 173 on its outer surface from the rim or annular base 152 of the waste cassette rotator 136. Before placing the cassette 172 in the chamber 132, the user also rotationally orientates the cassette 172 in order to locate the ribs 151 of the rotator 136 into the slots 171 of the cassette 172.

Alternatively, the cassette 172 can be supported at its base by the rim or annular base 152 of the waste cassette rotator 136.

In order to begin using a cassette 172 in the waste storage device 100, the user accesses flexible tubing housed within the cassette 172, pulls a length of tubing from the cassette storage section defined by the inner and outer walls 174, 176 and ties a knot in the end of the tubing as described above. The user then inserts the knot into a hook 144 on the under surface of the cover 104 of the device 100 as described above. As a result, a sealed hollow of tubing is formed in the throat of the waste storage device 100, radially inward of the inner wall 174 of the cassette 172. At this point the waste storage device 100 and cassette 172 are ready for insertion of a waste item into the hollow of tubing.

Once a user has placed a waste item in the hollow of tubing, he or she then actuates the handle 156 on the waste cassette rotator 136. Rotation of the waste cassette rotator 136 causes rotation of the cassette 172 located thereon. The ribs 151 of the rotator 136 and slots 171 of the cassette 172 act as cooperating inter—engagement means in a similar manner to a lug and recess arrangement, to ensure that the waste storage cassette 172 rotates synchronously with the waste cassette rotator 136.

The rotator 136 and waste storage cassette 172 rotate relative to the waste storage device 100. The contact force exerted by the stationary gripper 300 causes the waste item to remain stationary during rotation of the cassette 172. Rotation of the cassette 172 thereby causes the tubing to twist above the waste item, forming a seal.

According to a preferred embodiment, the waste cassette and waste storage device 100 are arranged so that one single rotation of the waste cassette 172 from its starting position by the waste cassette rotator 136 is sufficient both to grip the tubing above the waste item and form a twist in the tubing in order to complete a sealed waste package.

Once a sealed waste package has been formed as described above, the user can replace the lid 106 of the waste storage device 100 until he or she next wishes to use the device 100. The action of closing the lid 106 causes the plunger 108 to plunge through the aperture in the throat area defined by the gripping assembly, pushing the previously-formed waste package(s) through the throat and down towards the waste storage chamber 102 below. At the same time, this causes additional flexible tubing to be dispensed from the waste cassette 172 in a metered manner. As a result, the plunger 108 creates a hollow of flexible tubing above the previously—formed waste packages(s), wherein the base of the hollow is formed by the twisted tubing above the previously-sealed waste item. When the user next opens the lid 106 of the waste storage device 100, a waste item can be placed directly in the hollow which the plunger 108 has created. Therefore the user does not have to take any additional steps to prepare the cassette 172 for storage of subsequent waste items, once the lid 106 has been re-opened, nor does the user need to push the previously-formed package(s) down into the waste storage chamber 102 manually.

The plunger 108 is arranged to present a fresh area of tubing which is just big enough to receive a waste item comprising a waste nappy and allow a twist seal to be formed above the nappy, without using any additional flexible tubing unnecessarily. This ensures that the maximum possible number of waste packages can be formed from the flexible tubing stored within a single waste cassette 172, making the cassette more cost-effective and environmentally friendly.

A waste storage cassette 172 can be employed in the waste storage device 100 to form a plurality of consecutive waste packages which are stored in the waste storage chamber 102 connected below the cover 104. In order to empty the waste packages from the waste storage chamber 102, the inter-engagement means between the cover 104 and waste storage chamber 102 are released and the cover 104 is lifted from above the waste storage chamber 102. If a cassette 172 in the cover 104 still houses some flexible tubing, the unused flexible tubing extending from the cassette 172 will be continuous with the flexible tubing from which the waste packages have been formed. As described above, in order to release the unused flexible tubing from connection with the previously formed waste packages, the user rips the flexible tubing above the most recently formed waste packaging using the hook 144 and cutter 146 means provided on the underside of the cover 104. Preferably, the components in the cover are made from lightweight materials, so that the user can easily lift the cover and, if desired, hold it in one hand while using the other hand to hold and cut the tubing above the waste packages.

The various components of the waste storage device 100 are preferably formed from lightweight plastic or any other suitable material and can be moulded or otherwise formed in any appropriate manner. Preferably the surfaces of the device are wipe-clean.

The embodiments of the waste storage device described provide a hygienic, easy-to-use and cost-effective means for disposing of used nappies and other waste items.

The plunger provides means for preparing the waste storage device and cassette for repeated use by creating hollows of flexible tubing for waste items to be placed into. This saves time and effort for the user and also ensures that the user does not use additional flexible tubing unnecessarily.

By providing an inter-engagement means consisting of ribs on the rotate ring and slots on the cassette, slippage between the cassette and rotator can be virtually eliminated. Slippage can cause the twist formed above the waste item to be loose, which in turn can provide an inadequate seal. Reducing slippage between the rotator and the cassette waste storage means that the twists formed above each waste item respectively are consistently tight, improving the seal formed between consecutive enclosed waste packages.

It will be appreciated that the engagement features upon the waste storage cassette may vary, so long as they continue to ensure that the waste storage cassette is rotated when the rotator is turned by the user. For instance the relative size, shapes and locations of respective engaging slots (alternatively, grooves, depressions or recesses) and protrusions (alternatively, ribs or formations) on each of the rotator and the waste storage cassette may be freely varied. Whilst the ribs in the embodiments described above are placed on the rotator, and the corresponding slots/recesses are provided in an outer flange or formation of the cassette, it will be appreciated that these features could be interchanged, i.e. the ribs could be provided on an outer surface of the cassette, and corresponding slots/recesses could be provided on the rotator.

Furthermore, the shape of the waste storage cassette may vary, particularly with reference to those features that support the waste storage cassette within the receiving chamber and/or the rotator (particularly, flanges). At its most general, a waste storage cassette may be considered to be defined by the inner and outer walls forming the storage section, with other features of secondary importance.

Furthermore, as noted in the background section, it may that certain embodiments of the waste storage cassette are not intended to rotate within the receiving chamber of a waste storage device. That is, as waste items are passed through the tubular core of the waste storage cassette and enveloped by the tubular film, there may be not twist to the tubular film applied between each waste item. For non-rotating waste storage cassettes, engagement features may be absent or specifically intended to lock the waste storage into the receiving chamber, and the rotator may be dispensed with.

Particularly for non-rotating embodiments of the waste storage cassette, the shape and form may vary. For instance, it is not necessary for any part of the waste storage cassette to be circular. For instance, the tubular core may not be circular and may be any suitable shape.

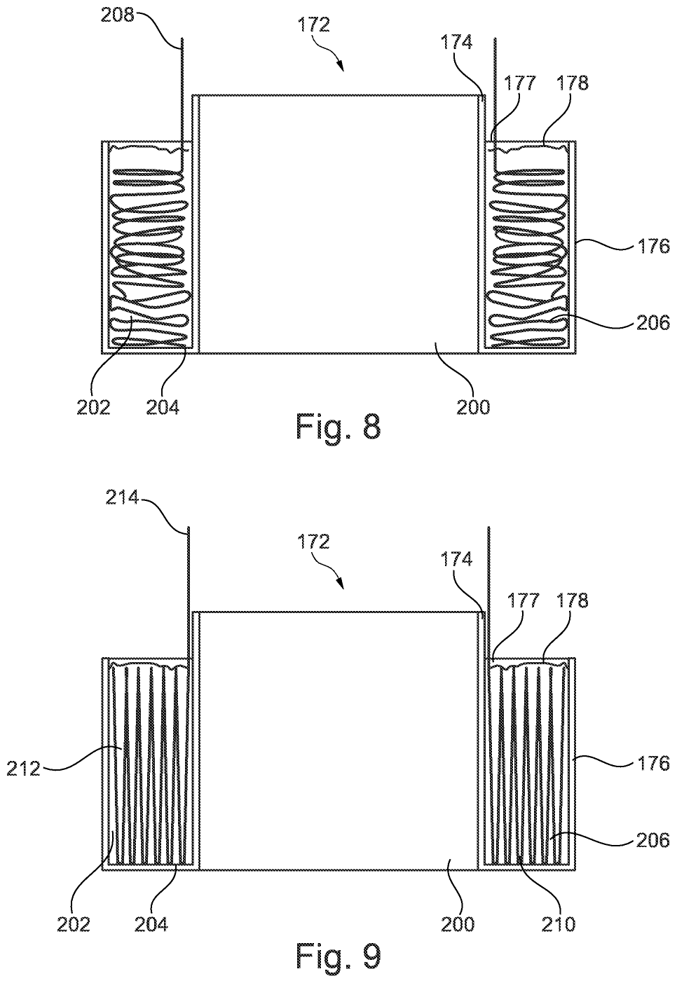

Referring now to FIG. 8, this illustrates a waste storage cassette 172, corresponding to that of FIGS. 6a to 6c, in cross section. Inner wall 174 defines a tubular core 200 (which as noted above need not be circular). Outer wall 176 is generally concentric with the inner wall 174 and defines a storage section 202 therebetween. At a lower side the storage section 202 is sealed by a base 204 which extends between the inner and outer walls 174, 176. At an upper side the storage section 202 is partially closed by flange 178 (best seen in FIG. 6c). The inner and outer walls 174, 176, base 204 and flange 178 define a waste storage cassette housing. As noted above the flange 178 is detachably coupled to the rest of the housing, but the remainder (including the rotator engagement features described above but not specifically illustrated in FIG. 8) may be formed as a single piece. Typically, the housing is formed from a rigid plastic.

Within the storage section 202 is stored a tubular film 206, which is also referred to herein as tubing or flexible tubing. Tubular film 206 is packed into the storage section 202 by machine prior to the flange 178 being secured to the outer wall 176. The tubular film may be stuffed by randomly creasing the tubular film as illustrated such that the layers are radial to the axis of the tubular core 200 and also the tubular film 206 as it is drawn from the storage section during use. An end 208 of the tubular film 206 is shown protruding from the storage section 202 through the peripheral gap 177 between the flange 178 and the inner wall 174.

The waste storage cassette 172 is provided filled with tubular film 206 as illustrated in FIG. 8. In use, the tubular film 206 is dispensed from the storage section 202, knotted off and passed through the tubular core 200 such that waste items inserted into the tubular core are enveloped by the film for hygienic disposal (as described above) and optionally the tubular film 206 is twisted between separate waste items for form a chain of sealed waste packages. Once the tubular film 206 is exhausted, the whole waste storage cassette 172 is replaced, including the housing.

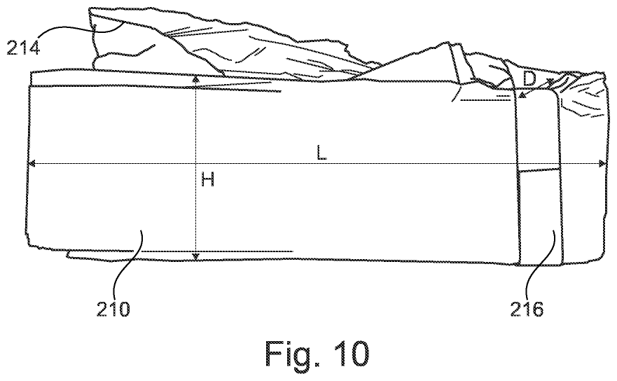

Turning now to FIGS. 9 and 10, a waste storage refill 210 according to an embodiment of the present invention will now be described. The waste storage refill 210 is used to refill a waste storage cassette housing which is empty of tubular film. That is, the waste storage refill 210 plus a housing form a complete waste storage cassette 172 ready for use. The waste storage refill 210 comprises a tubular film 206, which in substance (materials and thickness) may be same as the tubular film 206 within the waste storage cassette 172 of FIG. 8. Suitable materials and dimensions are described below. Advantageously, the use of a waste storage refill 210 reduces material waste by not requiring the housing part of the waste storage cassette 172 to be replaced once the film is used up. This provides both environmental benefits and cost savings.

The waste storage refill 210 comprises a tubular film 206 which is folded over in alternate directions to form concentric pleats 212 such that pulling an end 214 of the tubular film (which may extend longer than the adjacent pleats) axially expands the pleats 212. By concentric pleats 212 it is meant that the tubular film 206 is folded back overlapping itself in an axial direction (of the tubular film 206 itself), and the direction of fold is reversed each time such that the pleats 212 are stack in a radial direction.

This may alternatively be described as the pleats 212 being vertical (for the example where the folds of FIG. 8 are horizontal). Alternatively, the pleats 212 may be considered to be circumferentially disposed about the tubular film 206. An end 214, for instance an inner end as illustrated in FIG. 9, may be left longer to aid in the user pulling the tubular film 206 axially from the storage section 202 to dispense tubular film 206, but this is not essential.

Each pleat 212 may be substantially the same length to form a tight package of pleats 212, thereby maximising the length of tubular film 206 in a given package size. The waste storage refill 210 may be supplied squashed flat to further reduce its size. That is, the concentric pleats 212 may form a ring and once formed this may be squashed by drawing together two diametrically opposed points on the ring to form a package which is approximately cuboid as illustrated in FIG. 10. This may then be secured by passing one or more bands 216 about the waste storage refill 210 to prevent the ring from opening up. The bands 216 may be formed, for instance, from plastic, paper or an elastic material. This compressed form of the waste storage refill 210 may be desirable for shipping, and may for instance allow a refill to be posted to a consumer for them to refill a waste storage cassette 172. Folding flat in this way also reduces packaging materials and hence cost.

The dimensions of the waste storage refill 210 are selected to fit the waste storage cassette housing. Particularly, the dimensions are selected so that the inner circumference of the ring (once the bands 216 are removed and the ring opened up) passes over the tubular core 200 defined by the inner wall 174. Furthermore, the maximum thickness of the concentric pleats 212 must not exceed the size of the gap between the inner and outer walls 174, 176. Furthermore, the length of each pleat 212 between adjacent folds must not exceed the height of the storage section 202 between the base 204 and the flange 178. Suitable dimensions for the waste storage refill 210 package illustrated in FIG. 10 are as follows: length (L) approximately 264 mm (±3 mm), height (H) approximately 75 mm (±5 mm), depth (D, though the depth is not clearly visible in the side view of FIG. 10) 50 mm (±5 mm, and not including a loose end 214 if one is provided). The height dimensions corresponds to the length of each pleat 212 along the length of the tubular film 206 between folds and corresponds to the space between the base 204 and the flange 178 of the waste storage cassette 172. The depth is equal to twice the thickness of the pleats 212 (because the ring is squashed flat). Accordingly, the maximum depth is twice the gap between the inner and outer walls, such that the gap is approximately 25 mm. The length is the squashed length of waste storage refill package, and corresponds to a tubular core diameter of approximately 2*(L−D)/π=136 mm (length L minus the depth D, owing to the folded over concentric pleats at each end) divided by π. It will be appreciated that the dimensions of the waste storage refill 210 are dictated by the dimensions of the waste storage cassette 172 to be refilled, and may vary for different waste storage cassettes 172.

It has been found that folding the tubular film 206 to form concentric pleats 212 when manufacturing a waste storage refill 210 is space efficient and allows for a large length of tubular film to be packed into a small package size. One further parameter that dictates the length of tubular film 206 to be provided in a waste storage refill 210 is the thickness of the tubular film 206, which in part is determined by the material used and the weight of waste items expected to be inserted into the tubular film. For instance, the film may be 0.012 mm thick, ±10%. In another embodiment, the film may be between 0.005 mm and 0.02 mm thick. Indeed, it has been found that the space efficiency of forming concentric pleats 212 can exceed that of stuffing the same tubular film 206 into the storage section 202 as shown in FIG. 8, even allowing for the fact that the waste storage refill 210 must be slightly smaller than the storage section 202 to allow a user to readily insert a waste storage refill 210. A waste storage refill may comprise, for instance, upwards of 5 m of tubular film. For instance, 5 m to 30 m. For instance 10 m to 25 m. In certain examples, a waste storage refill may comprise 10.5 m or 17.5 m of tubular film. A benefit of fitting a larger length of tubular film into a waste storage refill 210 compared to the amount stuffed into a waste storage cassette 172 according to FIG. 8 is that the film runs out less frequently.

The tubular film may be manufactured from any suitable material known to the skilled person for packaging waste. It may be a plastic film of a type known for use in forming bin liners, for instance polyethylene. Particularly, low-density polyethylene (LDPE) or linear LDPE (LLDPE) may suitably be used. Other suitable plastics will be well known to the skilled person.

Alternatively, in order to further reduce the use of plastics (alongside the avoidance of replacing the waste storage cassette housing) a bioplastic may be used to form the tubular film. Suitable bioplastics may include those made from sugarcane derived ethylene.

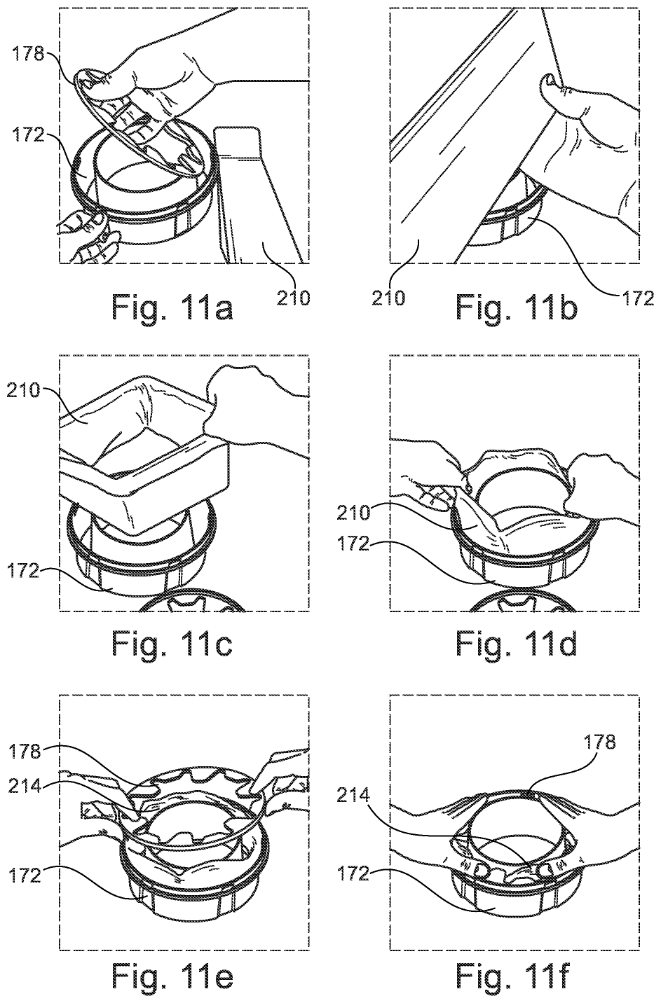

Referring now to FIGS. 11a to 11f, these illustrate the steps involved in using a waste storage refill 210 as described in FIGS. 9 and 10 to refill a waste storage cassette 172 (specifically, an empty housing from such a waste storage cassette). FIG. 11a illustrates the removal of the flange 178 from an empty waste storage cassette. As noted above, the flange 178 may be clipped or otherwise attached to the outer wall 176 allowing for its ready removal and access to the storage section 202. FIG. 11b illustrates the waste storage refill 210 being opened (after removing any securing band 216) to form a ring (which may not be circular, as illustrated, due to the way the refill is squashed flat), which may be passed over the inner wall 174 and inserted into the storage section (FIGS. 11c and 11d). FIGS. 11e and 11f show the flange being refitted. An end of the tubular is left protruding through the peripheral gap 177. The waste storage cassette 172, once refilled may be inserted into the waste storage device and used to package waste as described above.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers or characteristics described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. It will be also be appreciated that, throughout the description and claims of this specification, language in the general form of “X for Y” (where Y is some action, activity or step and X is some means for carrying out that action, activity or step) encompasses means X adapted or arranged specifically, but not exclusively, to do Y.

The reader's attention is directed to all papers and documents which are filed concurrently with or previous to this specification in connection with this application and which are open to public inspection with this specification, and the contents of all such papers and documents are incorporated herein by reference.

1. A waste storage refill for a waste storage cassette to be mounted in a waste storage device, the waste storage refill comprising:
a tubular film folded over in alternate directions to form concentric pleats such that pulling an end of the tubular film axially expands the pleats.

2. A waste storage refill according to claim 1, wherein the pleats are disposed circumferentially such that each pleat is parallel to the axis of the tubular film.

3. A waste storage refill according to claim 1, wherein each pleat comprises an approximately equal length of the tubular film.

4. A waste storage refill according to claim 1, wherein one end of the tubular film protrudes from the concentric pleats such that it may be pulled to axially expand the pleats.

5. A waste storage refill according to claim 1, wherein the concentric pleats are squashed together across the dimeter of the tubular film to form a flattened package that is openable such that the concentric pleats form a ring.

6. A waste storage refill according to claim 5, wherein the depth of the stacked concentric pleats in the flattened package is between 45 mm and 55 mm thick;
wherein each pleat is between 70 mm and 80 mm in the axial direction of the tubular film; or
wherein the length of the flattened package is between 261 mm and 267 mm.

7. A waste storage refill according to claim 1, wherein the tubular film is formed from a plastic or bioplastic.

8. A waste storage refill according to claim 1, wherein the tubular film is between 0.005 mm and 0.02 mm thick.

9. A waste storage cassette for mounting in a chamber provided in a waste storage device, the waste storage cassette comprising:
an inner wall defining a substantially tubular core;
an outer wall;
a storage section provided between the inner wall and the outer wall; and
a waste storage refill according to claim 1;
wherein the waste storage refill is located within the storage section surrounding the tubular core.

10. A waste storage cassette according to claim 9, wherein the outer wall includes at least one engagement feature configured to locate and engage with a corresponding engagement feature within the waste storage device.

11. A waste storage cassette according to claim 9, further comprising a flange detachably coupled to an upper edge of the outer wall and extending radially inward to at least partly cover the storage section.

12. A waste storage device comprising:
a receiving chamber provided in an upper part of the device; and
a waste storage cassette according to claim 9;
wherein the receiving chamber is configured to receive the waste storage cassette; and
wherein waste inserted into the waste storage device passes through the tubular core of the waste storage cassette and is enveloped in the tubular film drawn from the storage section.

13. A waste storage device according to claim 12, wherein the receiving chamber is configured such that the waste storage cassette can rotate relative to the receiving chamber, the waste storage device further comprising a rotator rotatably mounted in the receiving chamber and configured to engage the waste storage cassette to ensure rotational engagement between the rotator and the cassette.

14. A waste storage device according to claim 12, wherein the waste storage cassette is separable from the waste storage device.

15. A method of refilling a waste storage cassette, the waste storage cassette comprising an inner wall defining a substantially tubular core, an outer wall and a storage section provided between the inner wall and the outer wall, the method comprising:
inserting a waste storage refill according to claim 1 into the storage section such that the concentric pleats of the tubular film surround the tubular core.

16. A method of refilling a waste storage cassette according to claim 15, wherein the waste storage cassette further comprises a flange detachably coupled to an upper edge of the outer wall and extending radially inward to at least partly cover the storage section, the method further comprising detaching the flange from the outer wall prior to inserting the waste storage refill into the storage section, and replacing the flange afterwards.

17. A method of refilling a waste storage cassette according to claim 15, further comprising pulling an end of the tubular film from the storage section, passing the end of the tubular film through the tubular core and knotting the end of the tubular film.
